(19) United States
(12) Patent Application Publication
(10) Pub. No.: US 2014/0214690 A1
(43) Pub. Date: Jul. 31, 2014

(54) DETERMINING A COUNTEROFFER

(71) Applicant: HEWLETT-PACKARD DEVELOPMENT COMPANY, L.P., Houston, TX (US)

(72) Inventor: Mehmet Kivanc Ozonat, San Jose, CA (US)

(73) Assignee: Hewlett-Packard Development Company, L.P., Houston, TX (US)

(21) Appl. No.: 13/756,268

(22) Filed: Jan. 31, 2013

(51) Int. Cl. G06Q 50/18; G06Q 30/00

(52) U.S. Cl. CPC G06Q 50/188; G06Q 30/00
USPC 705/80

(57) ABSTRACT

A non-transitory computer-readable medium storing a set of instructions to determine a counteroffer can include the set of instructions executable by a processing resource to: determine, by an automated agent, a plurality of counteroffers to an offer received by a user; separate, by the automated agent, the plurality of counteroffers into a number of clusters based on content of each of the plurality of counteroffers and a determined distance between each of the plurality of counteroffers; select, by the automated agent, an individual counteroffer from each of the number of clusters based on the offer, characteristics of the user, and the determined distances; and present each of the individual counteroffers.

### BACKGROUND

Negotiation includes a process of reaching an agreement between two (or more) users (e.g., parties) on the issues underlying a transaction. Negotiations may be an integral part of business and can be instrumental in reaching agreements among the users.

Negotiation can be automated, such that an automated negotiation agent can negotiate on behalf of a consumer and/or business. Prior approaches to automated negotiation include making single counteroffers at each round, resulting in numerous rounds of negotiation and/or non-agreements.

### BRIEF DESCRIPTION OF THE DRAWINGS

FIG. 1 is a block diagram illustrating an example of a method for determining a counteroffer according to the present disclosure.

FIG. 2A illustrates an example of a coarsening process according to the present disclosure.

FIG. 2B illustrates an example of a partitioning process according to the present disclosure.

FIG. 2C illustrates an example of a refining process according to the present disclosure.

FIG. 3 illustrates an example system according to the present disclosure.

### DETAILED DESCRIPTION

Electronic commerce may offer many advantages, including increased operational efficiency for businesses, reduction of inventory costs, and availability of products and services 24 hours a day. However, previous approaches to electronic commerce systems lack an ability to enable businesses to negotiate with consumers during purchases.

Automated negotiation agents can negotiate issues of an e-commerce transaction with human consumers on behalf of e-commerce vendors (or vice versa), and they can increase the financial benefits of the consumers and the vendors jointly. Previous approaches to negotiation agents have focused on agents that are restricted to making a single counteroffer to the consumer(s) at every round of the negotiation.

For example, prior approaches to negotiation with automated agents may result in numerous rounds of negotiation with a single offer and single counteroffer each round (e.g., bilateral sequential negotiation) and/or offers and counteroffers consistently far away, which can lead to disagreements or non-agreements (e.g., game-theoretic approaches). In contrast, making multiple counteroffers per negotiation round, as discussed further herein, can be beneficial to both the consumer and the vendor.

The present disclosure includes an automated, online negotiation agent that can negotiate with consumers on behalf of businesses and can make multiple offers at every round of negotiation. A probabilistic model can be devised that guides the agent to find an optimal set of counteroffers.

In a number of examples, systems, methods, and computer-readable and executable instructions are provided for determining a counteroffer. A method for determining a counteroffer according to the present disclosure can include determining, by an automated agent, a plurality of counteroffers to an offer received by a user and separating, by the automated agent, the plurality of counteroffers into a number of clusters based on content of each of the plurality of counteroffers and a determined distance between each of the plurality of counteroffers. A method for determining a counteroffer can also include selecting, by the automated agent, an individual counteroffer from each of the number of clusters based on the offer, characteristics of the user, and the determined distances, and presenting each of the individual counteroffers.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P,” “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

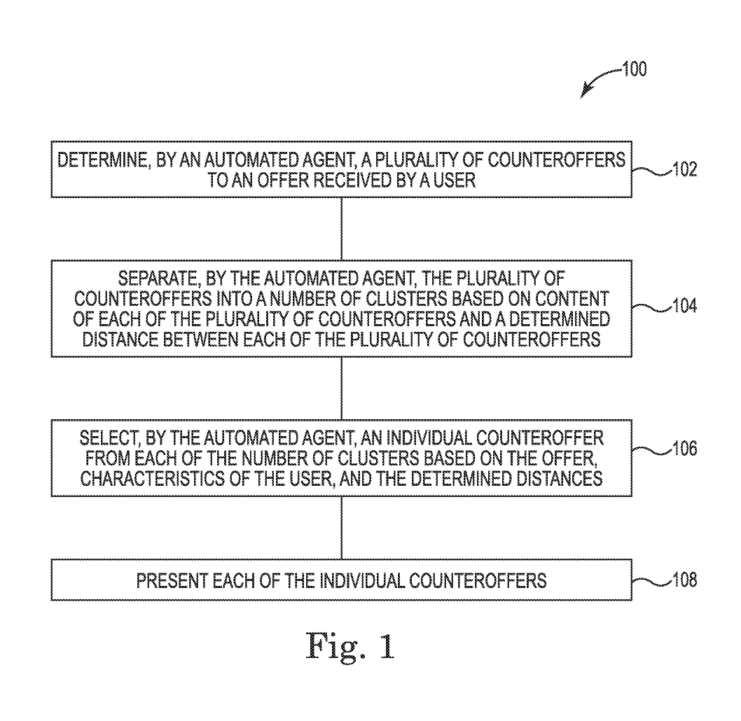

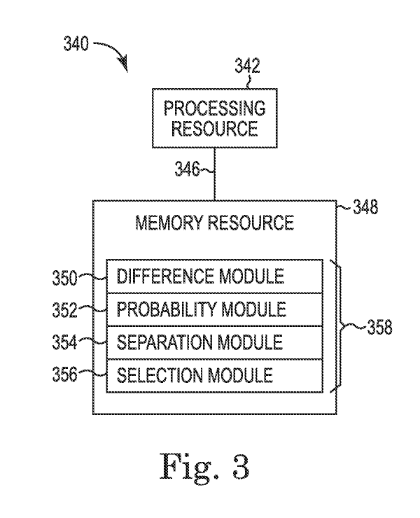

FIG. 1 is a block diagram illustrating an example of a method 100 for determining a counteroffer according to the present disclosure. In some examples, method 100 can be performed utilizing a non-transitory computer-readable medium storing set of instructions (e.g., as illustrated in FIG. 3), the set of instructions executable to perform method 100. In a number of embodiments, method 100 can be performed at each round of negotiation. For example, if a negotiation lasts three rounds, multiple counteroffers can be made at each of the three rounds.

At 102, an automated agent determines a plurality of counteroffers to an offer received by a user. As used herein, a user can include a party of a negotiation (e.g., buyer, seller, etc.) An automated agent (or “agent”) can comprise a non-transitory computer-readable medium storing a set of instructions, and can utilize knowledge of two or more users involved in a negotiation (e.g., a buyer and a seller) to assist in moving the negotiation forward towards an agreement. An agent can, for instance, negotiate with consumer(s) on behalf of a business.

In a number of examples, the automated agent may work on behalf of a buyer, a seller, or both. For example, an agent working on behalf of a seller may receive an offer from a buyer. The agent can determine a plurality of counteroffers to the offer, based on a negotiation history of the seller and the buyer, for instance.

The determined plurality of counteroffers can include both similar and different counteroffers. For example, if a seller has offered a blue personal computer with a 19 inch screen to a buyer for a particular price, the agent (e.g., working for the buyer) may determine counteroffers that include changes in color, price, and screen size, among others.

In a number of examples, it can be assumed that the negotiation agent has knowledge of (or can estimate from the buyer's or seller's history of offers during the negotiation) how close any two offers are from the perspective of the buyer and/or seller (depending on who the agent is serving). For example, an agent can be designed such that the agent makes counteroffers based on a buyer's utility function known to both users, and/or such that the agent makes counteroffers by estimating distances (e.g. how close counteroffers are to one another) between issue points in a vector space. For instance, an agent may offer as a counteroffer a point closest to the buyer's last offer based on some estimated distance.

It can also be assumed, for example, that for any buyer, there exists an “indifference volume” V(u) around each vector u in the issue space, defined as the set of issue vectors where the buyer's gains from preferring any v ∈ V(u) over u is very small. In particular, the buyer may be unlikely to risk termination of the negotiation by insisting on u instead of some other v ∈ V(u). For example, if a buyer is looking to purchase a personal computer costing in the range of 1,000 dollars, the buyer is unlikely to walk away from the negotiation if the seller and the buyer are 20 dollars apart in negotiation. In a number of examples, the agent does not know the size or shape of the volume V(u).

A buyer may be unlikely to form mathematical models (e.g., utility functions, iso-curves, etc.) upon which its counteroffer decisions are based. Instead, the buyer may be more likely to make its decisions based on a mixture of quantitative (e.g., cost) and qualitative (e.g., color) criteria. In a number of embodiments, an existence of an indifference volume around each issue vector is assumed, but assumptions about the size or the shape of the volume are not made. An issue vector (e.g., offer, counteroffer) can include a number of components of an offer or counteroffer. For example, with respect to purchasing a personal computer, an issue vector can include components, such as, for instance, price of a product or service, delivery time, quantity, memory, monitor size, etc.

Automated negotiation agents can include an offer strategy to offer the issue (e.g., the counteroffer or counteroffers) that is closest to the buyer's last offer among a set of issue vectors. The agent can form the set such that a number of issue vectors (e.g., all issue vectors) in the set have the same utility for the agent (e.g., the issue vectors are on the same agent utility isocurve). The agent can offer a member of the set as a counteroffer that is closest to the buyer's last offer. In this strategy, the distance between an issue vector u and the buyer's last offer y can be measured as a weighted sum of their element-wise distances, for example,

$$D ( u , y ) = {\sum }_{i} {w}_{i} {D}_{i} ( {u}_{i} , {y}_{i} ) , \qquad ( 1 )$$

where the uᵢ and yᵢ are the i^{th} elements of the vectors u and y, and the weights wᵢ are computed based on the estimated preferences of the buyer.

The agent can estimate these preferences from the buyer's negotiation and/or offer history (e.g., how the buyer acted in similar situations in previous negotiations). The distance measure Dᵢ can be, for instance, the element-wise absolute difference (|uᵢ−yᵢ|) between the two vectors. To make two (or more) offers (e.g., counteroffers) per round, the agent can select the closest two issue vectors to y on the agent's isocurve as offers (e.g., counteroffers). However, if the two closest vectors are within a close neighborhood of each other, for instance, this strategy may not add much beyond offering just one of these two vectors. For example, an offer of 1,110 dollars may be too close to an offer of 1,115 dollars.

Another approach to making two (or more) offers per round includes selecting the first offer as the closest one to y on the isocurve, and the second offer on the isocurve as far from the first offer as possible. However, in this strategy, the second offer may not take into account the buyer's offer y or his or her preferences (e.g., if it is assumed that the buyer offers y in the last round). If p_{y}(u₁) denotes the probability that the buyer terminates the negotiation in response to agent's offer u₁, and p_{y}(u₂|u₁) denotes the conditional probability that the buyer terminates the negotiation in response to the offer u₂ given the buyer would terminate it in response to u₁, then, by the definition of conditional probability, the probability of the buyer continuing with the negotiation is:

1−p_{y}(u₁,u₂)=1−p_{y}(u₁)p_{y}(u₂|u₁), (2)

and p_{y}(u₁) and p_{y}(u₂|u₁) can be modeled such that p_{y}(u₁) can be proportional to the distance between u₁ and y, such that:

p_{y}(u₁)=k₁|y−u₁|, (3)

for some constant k₁.

A conditional probability that u₂ gets rejected given that u₁ would be rejected, p_{y}(u₂|u₁), can depend on both the distance between y and u₂ and the distance between u₁ and u₂. In particular, as the distance between u₁ and u₂ decreases, the conditional probability depends more on the distance between u₁ and u₂. However, if the distance between u₁ and u₂ increases, the conditional probability is more dependent on the distance between y and u₂. For example let:

p_{y}(u₂|u₁)=k₂|y−u₂|if|u₁−u₂|≧∈, and

p_{y}(u₂|u₁)=1 if|u₁−u₂|<∈, (4)

for some constants k₂ and ∈.

The probability that the buyer will continue with the negotiation becomes:

1−p_{y}(u₁, u₂)=1−k₁k₂|y−u₁∥y−u₂|if|u1−u2|≧∈, and

1−p_{y}(u₁, u₂)=1−k₁|y−u₁|if|u₁−u₂|<∈. (5)

It can be noted that the probability k|y−u|<1 for any k₁, k₂, and u since p_{y} is a probability mass function.

If u₂ is placed very close to u₁ (e.g., within a distance of ∈), then the acceptance probability is lower than the case with u₂ placed far away from u₁ (e.g., outside a distance of ∈). This follows from:

1−k₁k₂|y−u₁∥y−u₂|>1−k₁|y−u₁|, (6)

since k|y−u|<1 for any k₁, k₂, and u.

The probability of continuing with the negotiation can be extended to N>2 offers, and it can be shown that with N simultaneous agent offers, the probability of the buyer walking away from the negotiation is reduced (e.g., minimized) if no two offers are within a distance of ∈. In this case, the probability of the buyer walking away from the negotiation is:

Πkᵢ|y−uᵢ|∥, (7)

provided no two offers are within a distance of ∈ of each other.

Minimizing model (7) can be, for example, equivalent to minimizing:

$${\sum }_{i} log {k}_{i} + log \vert y - {u}_{i} \vert . \qquad ( 8 )$$

The optimization problem in (7) may be intractable, and as a result, a suboptimal strategy can be used to minimize (8). The agent can utilize model (8), in a number of examples, to determine counteroffers in response to an offer received by a user (e.g., buyer or seller).

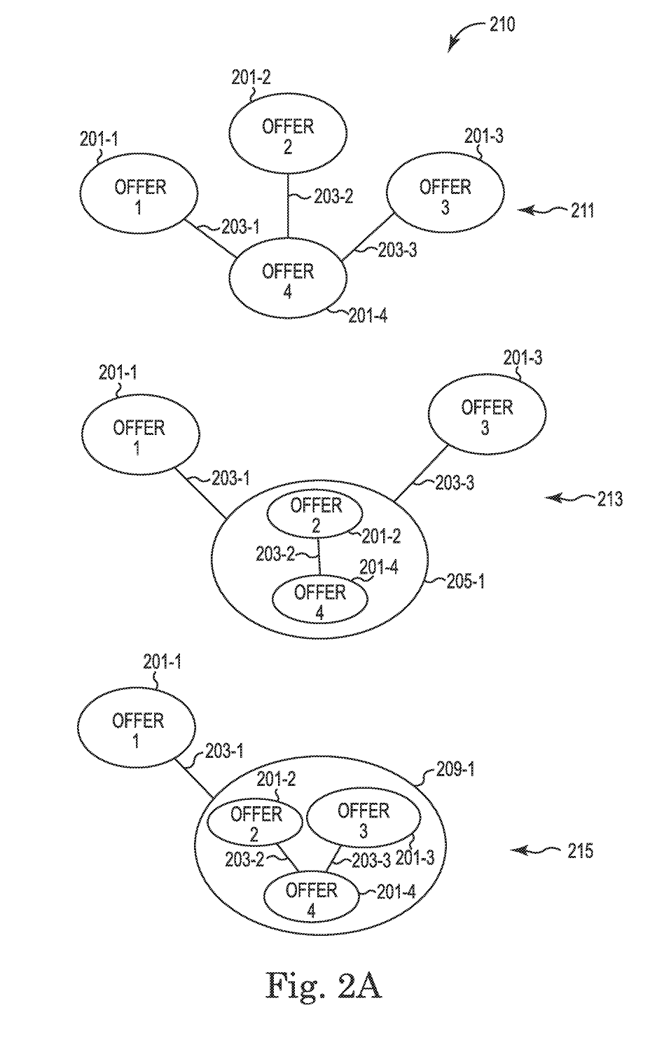

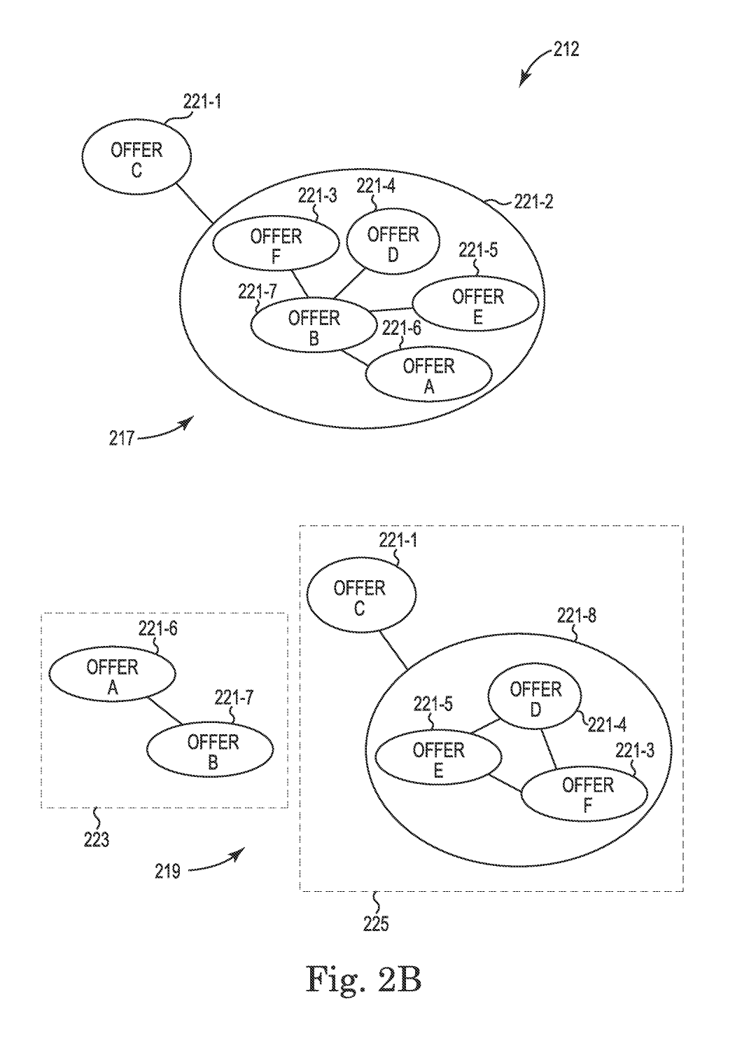

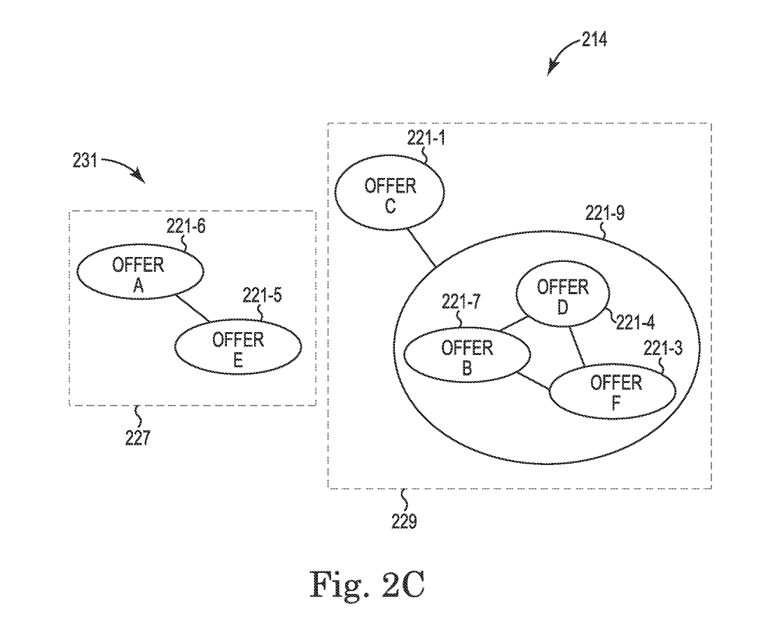

At 104, the automated agent separates the plurality of counteroffers into a number of clusters based on content of each of the plurality of counteroffers and a determined distance between each of the plurality of counteroffers. In a number of embodiments, as will be discussed further herein with respect to FIGS. 2A-2C, determining a counteroffer can include partitioning an issue space using graph partitioning (e.g., clustering) into multiple clusters such that the partitioning satisfies the following conditions: any two issue vectors, u and v, within the same clusters (e.g., intra-cluster) are close (or likely to be close) to each other (e.g., . within a threshold distance ∈), and any two issue vectors, u and v, between two clusters(e.g., inter-cluster) are far (or likely to be far) from each other (e.g., outside a threshold distance of ∈). In other words, counteroffers can be clustered based on their proximity, such that intra-cluster distances are below a threshold and inter-cluster distances are above a threshold. For example, a red widget and a blue widget may be in separate clusters, while a red widget and a red-orange widget may be clustered together. Distances between counteroffers (whether intra- or inter-cluster) can be determined, for example, by utilizing a set of distance metrics.

In a number of examples, as will be discussed further herein with respect to FIGS. 2A-2C, graph clustering can comprise coarsening a semantics graph associated with the plurality of counteroffers, wherein the semantics graph contains a plurality of nodes in a number of sub-graphs containing multinodes. Graph clustering can also comprise partitioning each of the number of sub-graphs into a number of clusters and iteratively refining the number of clusters to reduce an edge-cut of the semantics graph, based on the number of clusters.

At 106, the automated agent selects an individual counteroffer from each of the number of clusters based on the offer, characteristics of the user, and the determined distances. Characteristics can include, for example, a user's negotiation history, a user's noted negotiation preferences, etc. In some examples, the determined distance comprises how related the content of each of the number of counteroffers is to one another, wherein the determined distance is based on a negotiation history of the user, as will be discussed further herein. An issue vector from each cluster can be selected as an offer (e.g., counteroffer), and in some examples, in each cluster, the offer that is closest to the last offer of the buyer can be selected (e.g., the offer closest to the buyer's last offer in the issue space is selected). As a result, remaining offers are not undesirably close.

In a number of embodiments, only one counteroffer per cluster is chosen. As noted above, counteroffers within the same cluster are similar (e.g., in the eyes of a party making the counteroffer). Utilizing multiple counteroffers from the same cluster may result in a higher probability of negotiation termination by the opposing user, as the counteroffers are too similar to consider.

In some examples, the agent may not have perfect estimates of the user's preferences wᵢ, and inaccuracies in estimating preferences may impact the distance function. By making multiple offers and/or counteroffers, these inaccuracies can be overcome. In a number of embodiments, it can be assumed that Dᵢ is the Euclidean distance or the city-block distance (e.g., the absolute element-wise difference between vectors).

At 108, each of the individual counteroffers is presented. The counteroffers may be presented to the user that received the offer or to the user that made the offer. For example, if a buyer receives an offer from a seller, the agent may present the individual counteroffers to the buyer to review prior to presenting them to the seller. The agent may present the individual counteroffers to the buyer after or at the same time as presenting them to the seller. Alternatively, the agent can present the individual counteroffers to the seller without presenting the counteroffers to the buyer.

FIGS. 2A-2C illustrate example processes for clustering counteroffers in accordance with the present disclosure. Counteroffers can be clustered, such that similar counteroffers (e.g., issue vectors) are clustered together, while dissimilar counteroffers are not clustered together. For example, two counteroffers in the same cluster may be considered the same offer (because they are similar). These clusters can be based, in part, on the offer provoking the counteroffers and characteristics of the user (e.g., buyer or seller). This clustering can be performed utilizing graph clustering, for example.

In a number of examples, V can denote a finite set of elements, and E can be a set of edges e such that each edge connects elements in V. G=(V,E) can be called a graph with the vertex set V and an edge set E. A weighted graph can be a graph that has a positive number w(e) associated with each edge e, called the weight of edge e. A weighted graph can be denoted by G=(V,E,w). An edge e can be incident with a vertex u when e connects u to another edge.

There can be a path between vertices v₁ and vₖ when there is an alternative sequence of distinct vertices and edges v₁, e₁, v₂, e₂, . . . , eₖ₋ᵢ, vₖ such that vᵢ, vᵢ₊₁ ∈ eᵢ, for 1≦i≦k−1. A graph is connected if there is a path for every pair of vertices.

A graph clustering model with k clusters can be formalized as follows: Given a graph G=(V,E), a clustering V₁, V₂, . . . , Vₖ can be found that reduces (e.g., minimizes) the number of edges of E whose incident vertices belong to different subsets, provided:

Vᵢ∩Vⱼ=0 for i≠j,

|Vᵢ|=|V|/k, and ∪ᵢVᵢ=Vᵢ.

If the edges have weights associated with them, the graph clustering model can be extended to account for the edge weights. For example, the model can be formulated as reducing (e.g., minimizing) the sum of the edge weights belonging to different subsets provided the two conditions listed above. Given a clustering, the number of edges whose incident vertices belong to different subsets can be called the edge-cut of the clustering. The graph G can be clustered using a multi-level model.

The graph G can be coarsened down (e.g., to a few hundred vertices), a partitioning of this smaller graph into k clusters can be computed, and this partition can be projected back towards the original graph (e.g., finer graph). As the graph is uncoarsened, the partition is further refined. The refinements can reduce the edge-cut since the finer graph has more degrees of freedom.

For example, a weighted graph G₀=(V₀, E₀) with weights both on the edges can be considered. An example multi-level graph clustering model can include the following phases, as will be discussed further herein with respect to FIGS. 2A-2C:

Coarsening Phase: The graph G₀ is transformed into a sequence of smaller graphs G₁, G₂, . . . , Gₘ such that V₀>V₁>V₂> . . . >Vₘ.

Partitioning. Phase: A 2-way partition Pₘ of the graph Gₘ=(Vₘ, Eₘ) is computed that partitions Vₘ into two parts, each containing half the vertices of G₀.

Uncoarsening (e.g., refining) Phase: The partition Pₘ of Gₘ is projected back to G₀ by going through intermediate partitions Pₘ₋₁, Pₘ₋₂, . . . , P₁, P₀.

FIG. 2A illustrates an example of a coarsening process 210 according to the present disclosure. A coarsening process 210 for clustering counteroffers can include coarsening a subset of counteroffers (e.g., nodes in a semantics graph). As shown at 211, a subset of counteroffers can include the nodes “Offer 1” 201-1, “Offer 2” 201-2, “Offer 3” 201-3, and “Offer 4” 201-4 connected by edges 203-1, 203-2, and 203-3. Edges 203-1, 203-2, and 203-3 can be weighted with a numerical value, for instance, representing a distance metric and/or a co-occurrence metric. In a number of examples, counteroffers 201-1, 201-2, and/or 201-3 can be weighted with a numerical value.

As shown at 213, a first sub-graph containing multinode 205-1 can be created by condensing counteroffers 201-1 and 201-2 during a first coarsening iteration. A multinode can include a number of nodes and the edges connecting the number of nodes. For instance, multinode 205-1 can include counteroffers 201-2 and 201-4, as well as edge 203-2.

As shown at 215, a second sub-graph containing multinode 209-1 can be created by condensing multinode 205-1 with counteroffer 201-3 during a second coarsening iteration, such that the number of incident edges is reduced to 1. For instance, multinode 209-1 can include counteroffers 201-2, 209-1 and 201-4, as well as edges 203-2 and 203-3, and can be connected to counteroffer 201-1 by edge 203-1.

Each coarsening iteration can include a matching of nodes (e.g., counteroffers) within the graph. For example, a matching of a graph Gᵢ=(Vᵢ, Eᵢ) can be a set of edges such that no two edges are incident on the same vertex. The coarser graph Gᵢ₊₁ can be constructed from Gᵢ by finding a matching of Gᵢ and collapsing the matched vertices into multinodes. The unmatched vertices can be copied over to Gᵢ₊₁. The matching of a graph can be obtained through forming maximal matchings, for example. A matching is maximal if any edge in the graph that is not in the matching has at least one of its endpoints matched. A maximal matching can be generated using a randomized model as follows: List the vertices in random order; if a vertex u has not been matched yet, then randomly select one of its unmatched adjacent vertices; if such a vertex v exists, include the edge (u, v) in the matching and mark vertices u and v as being matched; and if there is no unmatched adjacent vertex v, then vertex u remains unmatched in the random matching. The complexity of the above model can be O(E).

In a number of embodiments, reducing (e.g., minimizing) an edge cut can be targeted in graph matching. For example, a graph Gᵢ=(Vᵢ,Eᵢ), a matching Mᵢ that is used to coarsen Gᵢ, and its coarser graph Gᵢ₊₁=(Vᵢ₊₁,Eᵢ₊₁) induced by Mᵢ can be considered. If A is a set of edges, W(A) can be defined to be the sum of the weights of the edges in A. It can be shown that:

W(Eᵢ₊₁)=W(Eᵢ)−W(Mᵢ). (9)

As a result, the total edge weight of the coarser graph is reduced by the weight of the matching. By selecting a maximal matching Mᵢ whose edges have a larger weight, the edge-weight of the coarser graph can be decreased by a larger amount as compared to edges with a smaller weight. Since the coarser graph has smaller edge-weight, it also has a smaller edge-cut.

Finding a maximal matching that contains edges with larger weights can be referred to as heavy-edge matching. A heavy-edge matching can be computed using a randomized model similar to that for computing a random matching described above. The vertices are visited in random order; however, instead of randomly matching a vertex u with one of its adjacent unmatched vertices, u is matched with the vertex v such that the weight of the edge (u, v) is increased (e.g., maximum) over all valid incident edges (heavier edge). In other words, each coarsening iteration of the graph can include a series of matching iterations to reduce the number of nodes.

For instance, a weighted graph can start with 10,000 nodes. After a first coarsening iteration, the weighted graph can include a number of subgraphs containing a number of multinodes and/or nodes, wherein the total number of multinodes and/or nodes in the weighted semantics graph can be 9,000. After the second coarsening iteration, the weighted semantics graph can include a number of sub-graphs containing a number of multinodes and/or nodes, wherein the total number of multinodes and/or nodes can be 8,200.

FIG. 2B illustrates an example of a partitioning process 212 according to the present disclosure. Partitioning process 212 can include computing a bisection of a number of subgraphs. For example, process 212 can include computing bisection (e.g., a small edge-cut) Pₘ of a coarse graph Gₘ=(Vₘ, Eₘ) such that each part contains roughly half of the vertex weight of the original graph. Since during coarsening the weights of the vertices and edges of the coarser graph are set to reflect the weights of the vertices and edges of the finer graph, Gₘ can contain information to enforce balanced partition and small edge-cut requirements. A Kernighan-Lin (KL) model can be utilized. The KL model is iterative in nature, and includes the following iterations: start with an initial partition of the graph; search for a subset of vertices from each part of the graph such that swapping them leads to a partition with a smaller edge-cut; and stop if two such subsets cannot be found.

This can indicate that the partition is at a local minimum. Each iteration of the KL model described can take O(EIogE) time. The KL model can find locally optimal partitions when it starts with a particular initial partition (e.g., a “good” or desirable initial partition) and when the average degree of the graph is of a particular size (e.g., a threshold size or a desired size). If a desirable initial partition is not known, the KL model can be repeated with different randomly selected initial partitions, and the one that yields the smallest edge-cut can be selected.

For example, P as the initial partition of the vertices of Gₘ=(Vₘ,Eₘ) can be considered. The gain gᵥ, of a vertex v can be defined as the reduction on the edge-cut if vertex v moves from one partition to the other. This gain can be given by:

$${g}_{v} = {\sum }_{( v , u ) ∈ E ⋂ P [ v ] \neq [ u \}} w ( u , v ) - {\sum }_{( v , u ) ∈ E ⋂ P [ v ] = P [ u )} w ( u , v ) , \qquad ( 10 )$$

where w(v, u) is weight of edge (v, u).

If gᵥ is positive, then by moving v to the other partition the edge-cut decreases by gᵥ, whereas if gᵥ is negative, the edge-cut increases by the same amount. If a vertex v is moved from one partition to the other, then the gains of the vertices adjacent to v may change. Thus, after moving a vertex, gains of its adjacent vertices can be updated. Given this definition of gain, the KL model can repeatedly select from the larger part a vertex v with the largest gain and move it to the other part. After moving v, v can be marked so it will not be considered again in the same iteration, and the gains of the vertices adjacent to v can be updated to reflect the change in the partition. The original KL model can continue moving vertices between the partitions until all the vertices have been moved.

For instance, as shown in FIG. 2B, sub-graph 217 can include a node “Offer C” 221-1 that has a vertex weight of C, connected to multinode 221-2 which includes the nodes “Offer F” 221-3, “Offer D” 221-4, “Offer E” 221-5, “Offer A” 221-6, and “Offer B” 221-7, with vertex weights of F, D, E, A, and B, respectively. The partitioning process 212 can include creating a partitioned graph 219 by partitioning sub-graph 217 into two clusters 223 and 225, wherein cluster 223 and cluster 225 each have a vertex weight of half of the total vertex weight of sub-graph 217 (e.g., weights A+B+C+D+E+F). That is, cluster 223 can include nodes 221-6 and 221-7, whereas cluster 225 can include nodes 221-1, and multinode 221-8 wherein multinode 221-8 includes nodes 221-5, 221-4, and 221-3.

FIG. 2C illustrates an example of a refining process 214 according to the present disclosure. The refining process 214 can include switching a node or subset of nodes between a pair of clusters to reduce the edge-cut of the partitioned graph 219 (illustrated in FIG. 2B). For instance, the edge-cut of the partitioned graph 219 can include the numerical value of X indicating the number of incident edges belonging to different subsets of nodes (e.g. edge-cut). In contrast, the edge-cut of the refined graph 231 can include the numerical value of X-1, indicating a reduced edge-cut. In a number of examples, the refined graph 219 can be iteratively refined by switching a pair of nodes and/or subsets of nodes between clusters 227 and 229 until the edge-cut of the refined graph 231 cannot be reduced any further.

For example, during uncoarsening, the partition Pₘ of the coarser graph Gₘ is projected back to the original graph, by going through the graphs Gₘ₋₁ Gₘ₋₂, . . . , G₁. Since each vertex of Gᵢ₊₁ contains a distinct subset of vertices of Gᵢ, obtaining Pᵢ from Pᵢ₊₁ is done by assigning the set of vertices Vᵢ^{v} collapsed to v ∈ Gᵢ₊₁, to the partition Pᵢ₊ᵥ[v].

Even though Pᵢ₊₁ is a local minimum partition of Gᵢ₊₁, the projected partition Pᵢ, may not be at a local minimum with respect to Gᵢ. Since Gᵢ is finer, it has more degrees of freedom that can be used to improve Pₕ and decrease the edge-cut. Hence, it may still be possible to improve the projected partition of Gᵢ₋₁ by local refinement heuristics. For this reason, after projecting a partition, a partition refinement model can be used. The partition refinement model can be used to select two subsets of vertices, one from each part, such that when swapped, the resulting partition has a smaller edge-cut.

The refinement model comprises the following: use the projected partition of Gᵢ₊₁ onto Gᵢ as the initial partition (e.g., if the projected partition is already a “good” partition); apply vertex swaps to decrease the edge-cut:

$${g}_{c} = {\sum }_{( v , u ) ∈ E ⋂ P [ v ] \neq P [ u )} w ( u , v ) - {\sum }_{( v , u ) ∈ E ⋂ P [ v ] = P [ u \}} w ( u , v ) ; \\ and \qquad ( 11 )$$

terminate the model when no further decrease in the edge-cut can be made through edge swaps.

As a result of the clustering (e.g., clustering, matching, partitioning, and refining), a user may have multiple offers to present in response to an offer, which can increase the likelihood that the offering user will accept one of the counteroffers. The individual counteroffers can encompass a user's preferences, and the individual counteroffers can be different enough that the offering user has a number of viable options.

In a number of examples of the present disclosure, negotiations can focus on single-issue negotiation settings and multi-issue negotiation settings. For example, when purchasing a personal computer, a single-issue negotiation may focus only on the brand of computer, while a multi-issue negotiation may focus on the brand, color, and memory of the computer.

When negotiating in a single-issue negotiation setting, a time- or resource-dependent tactic can be utilized to determine how the offer (e.g., an issue vector) y_{n,d} changes as a function of time n (or as a function of a resource). Resource-dependent tactics may include a generalization of the time-dependent tactics, where resources other than time (e.g., inventories) are considered. Behavior dependent tactics can also be used in single-negotiation settings and can determine how the issue offer y_{n,d} changes as a function of the counteroffers of the opposing user (e.g., opposing party).

The evolution of the offer y_{n,d} through time can be given as:

y_{n,d}=y_{min,d}+α_{d}(n)(y_{max,d}−y_{min,d}), (12)

where [y_{min,d} y_{max,d]} is the range of values for issue d, and α_{d} is a time-varying function.

Function α_{d} can include a number of different functions, such that each function is monotonic in the issue value, and has five parameters: β_{d}, tₘₐₓ, y_{min,d}

, y_{max,d}, and κ. The parameter β_{d} controls the convexity of the function. When β_{d}<1, the function is convex, and when β_{d}>1 the function is concave. The following is one such example function:

α_{d}(n)=θ+(1−κ)(min(n, tₘₐₓ)/tₘₐₓ)^{1/β}^{_{d}}. (13)

Of the five parameters, K is a constant (e.g., usually set to 0), β_{d} controls the concession behavior, and tₘₐₓ is the maximum number of negotiation rounds (e.g., predetermined maximum number of negotiation rounds chosen by buyer, seller, or both). The notation min(n, tₘₐₓ) implies the smaller of n and tₘₐₓ. As β_{d} is decreased, the user makes more “boulware” offers, (e.g., the user stays closer to the y_{min,d} value until the time is almost exhausted, whereupon it concedes up to y_{max,d}). As β_{d} is increased, the user makes more “conceder” offers (e.g., the user quickly moves up to y_{max,d}).

When the negotiation involves multiple issues, the dependencies among the issues may be considered. For example, an assumption can be made that a negotiating user starts with an initial issue vector with utility equal to Uᵢₙᵢₜᵢₐₗ and aims to reach an agreement at a target vector with utility U_{target}. In a number of embodiments, U_{target} is less than Uᵢₙᵢₜᵢₐₗ. In some examples, the user decreases the utility value monotonically at every round.

To extend this to simulating buyer's behavior in a multi-issue setting, one of the buyer's target vectors can be randomly selected as y_{max,d}. Another vector can be randomly selected as y_{min,d}, such that each element of y_{max,d} is greater than or equal to the corresponding element of y_{min,d}. This condition can result in the monotonic functions (e.g., function (13)) being used to move from y_{min,d} to y_{max,d} in a finite number of rounds. At each time n, either the β_{d} value can be kept for each issue d (e.g., no change in the state), or a switch can be made to a new β_{d} value for each issue d according to some prior transition probability.

The parameter β_{d} can be selected to ensure the convexity (or concavity) of α_{d}. As discussed previously with respect to single-issue negotiation settings, the negotiator's tactic can be characterized as either “boulware” or “conceder.” In particular, for β_{d}<1, the tactic is boulware, while for β_{d}>1, the tactic is conceder. Function (13) is convex in n, and the degree of convexity, determined by the value of β_{d}, identifies the tactic. As β_{d} is increased, the offers get more conciliatory, and as β_{d} is decreased, the offers become more boulware.

Since a function is (strictly) convex if and only if its second derivative is (strictly) non-negative, and since a weighted sum of second derivatives is equal to the second derivative of the weighted sums, it follows that the additive utility function, U, defined as:

$$U = {\sum }_{d} {w}_{d} {U}_{d} , \qquad ( 14 )$$

for some weights w_{d}>0, and the issue utilities U_{d}, is convex (e.g., guaranteed to be convex) as long as β_{d}<1 for each d, and is cocave (e.g., guaranteed to be concave) as long as β_{d}>1 for each d. Thus, in transitioning from one set of β_{d} values to another in the simulations, in each state either β_{d}<1 for each d or β_{d}>1 for each d. This can ensure the convexity (or the concavity) in the utility space as well as in the issue space.

FIG. 3 illustrates a block diagram of an example of a system 340 according to the present disclosure. The system 340 can utilize software, hardware, firmware, and/or logic to perform a number of functions.

The system 340 can be any combination of hardware and program instructions configured to determine a counteroffer. The hardware, for example can include a processing resource 342, a memory resource 348, and/or computer-readable medium (CRM) (e.g., machine readable medium (MRM), database, etc.) A processing resource 342, as used herein, can include any number of processors capable of executing instructions stored by a memory resource 348. Processing resource 342 may be integrated in a single device or distributed across devices. The program instructions (e.g., computer-readable instructions (CRI)) can include instructions stored on the memory resource 348 and executable by the processing resource 342 to implement a desired function (e.g., determining a counteroffer).

The memory resource 348 can be in communication with a processing resource 342. A memory resource 348, (e.g., CRM) as used herein, can include any number of memory components capable of storing instructions that can be executed by processing resource 342, and can be integrated in a single device or distributed across devices. Further, memory resource 348 may be fully or partially integrated in the same device as processing resource 342 or it may be separate but accessible to that device and processing resource 342.

The processing resource 342 can be in communication with a memory resource 348 storing a set of CRI 358 executable by the processing resource 342, as described herein. The CRI 358 can also be stored in remote memory managed by a server and represent an installation package that can be downloaded, installed, and executed. Processing resource 342 can be coupled to memory resource 348 within system 340 that can include volatile and/or non-volatile memory, and can be integral or communicatively coupled to a computing device, in a wired and/or a wireless manner. The memory resource 348 can be in communication with the processing resource 342 via a communication link (e.g., path) 346.

Processing resource 342 can execute CRI 358 that can be stored on an internal or external memory resource 348. The processing resource 342 can execute CRI 358 to perform various functions, including the functions described with respect to FIGS. 1, 2A, 2B, and 2C.

The CRI 358 can include modules 350, 352, 354, 356. The modules 350, 352, 354, 356 can include CRI 358 that when executed by the processing resource 342 can perform a number of functions, and in some instances can be sub-modules of other modules. For example, the difference module 350 and the probability module 352 can be sub-modules and/or contained within the same computing device. In another example, the number of modules 350, 352, 354, 356 can comprise individual modules at separate and distinct locations (e.g., CRM etc.).

In some examples, the system can include a difference module 350. A difference module 350 can include CRI (e.g., an automated negotiation agent) that when executed by the processing resource 342 can determine a difference between each of a number of counteroffers to an offer presented by a first user and received by a second user based on a negotiation history of the first user and the second user. For example, a set of distance metrics between each of the plurality of counteroffers can be determined. Utilizing these determined distance metrics, similarities and differences between each of the counteroffers can become apparent and can be utilized for clustering the counteroffers.

A probability module 352 can include CRI that when executed by the processing resource 342 can determine a probability of acceptance of each of the number of counteroffers by the first user based on elements of the offer. For example, it can be determined how likely it is that a user (e.g., a buyer) will walk away from a negotiation in response to a counteroffer. This can be based, for instance, on components of the counteroffer such as price and delivery time, among others. By reducing (e.g., minimizing) these probabilities a user (e.g., a seller) can increase the likelihood of moving forward with negotiations.

A separation module 354 can include CRI that when executed by the processing resources 342 can separate the number of counteroffers into a number of clusters based on the distance between each of the plurality of counteroffers and the probability of acceptance. For example, utilizing the distance and the probability, graph clustering can be performed to determine an optimal set of counteroffers. In some examples, the plurality of counteroffers can be separated or “clustered” such that intra-cluster counteroffer distances are below are particular threshold (e.g., below distance ∈) and inter-cluster distances are above a particular threshold (e.g., above distance ∈).

A selection module 356 can include CRI that when executed by the processing resource 342 can select from each of the number of clusters a counteroffer to present to the first user. Because counteroffers within the same cluster are similar in the eyes of the user making the counteroffer, only one counteroffer from each cluster is selected. Choosing two counteroffers from the same cluster may result in a higher probability of negotiation termination by the opposing user. In some examples, a counteroffer from each cluster is chosen, such that the chosen counteroffer is the counteroffer closest to the offer (e.g., the last offer made).

In a number of examples, the processing resource 342 coupled to the memory resource 348 can execute CRI 358 to receive an first offer from a first user to a second user and determine and present a first plurality of counteroffers to the first user from the second user based on the first offer and characteristics of the second user. For example, in response to receiving a first offer from a first user, a second user (e.g., via an automated negotiation agent) can determine, utilizing graph clustering, a first plurality of counteroffers to send back to the first user. This determination can be based on, for example, the first and second users' past negotiation history and current and/or past negotiation preferences.

The processing resource 342 coupled to the memory resource 348 can execute CRI 358 to receive a second offer from the first user to the second user in response to the first plurality of counteroffers and determine and present a second plurality of counteroffers to the first user from the second user based on the second offer and characteristics of the second user. For example, in response to receiving a rejection of the first plurality of counteroffers, the second user may receive a second offer from the first user. The second user can determine, utilizing graph clustering, a second plurality of counteroffers to send back to the first user. This determination can again be based on, for example, the first and second users' past negotiation history and current and/or past negotiation preferences. In a number of embodiments, the multiple counteroffers per round can continue through any number of rounds of negotiation.

In some instances, the processing resource 342 coupled to the memory resource 348 can execute CRI 358 to determine particular counteroffers that reduce a probability that the first user will terminate negotiations in response to receiving each of the first and second plurality of counteroffers. This can result in more successful negotiations, such that the likelihood of negotiating without reaching an agreement is reduced.

The processing resource 342 coupled to the memory resource 348 can execute CRI 358, when determining the first plurality of counteroffers, to associate an issue vector with each of the first plurality of counteroffers, cluster the associated issue vectors based on their proximity to one another, select, from each cluster, an issue vector that is closest to the first offer received by the user and present the selected issue vectors as counteroffers to the first offer.

Similarly, the processing resource 342 coupled to the memory resource 348 can execute CRI 358 when determining the second plurality of counteroffers, to associate an issue vector with each of the second plurality of counteroffers, cluster the associated issue vectors based on their proximity to one another, select, from each cluster, an issue vector that is closest to the second offer received by the user and present the selected issue vectors as counteroffers to the second offer.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A non-transitory computer-readable medium storing a set of instructions to determine a counteroffer, the set of instructions executable by a processing resource to:
determine, by an automated agent, a plurality of counteroffers to an offer received by a user;
separate, by the automated agent, the plurality of counteroffers into a number of clusters based on content of each of the plurality of counteroffers and a determined distance between each of the plurality of counteroffers;
select, by the automated agent, an individual counteroffer from each of the number of clusters based on the offer, characteristics of the user, and the determined distances; and
present each of the individual counteroffers.

2. The non-transitory computer-readable medium of claim 1, wherein the instructions executable to present each of the individual counteroffers comprise instructions executable to present each of the individual counteroffers to the user.

3. The non-transitory computer-readable medium of claim 1, wherein the instructions executable to present each of the individual counteroffers comprise instructions executable to present each of the individual counteroffers to a user that made the offer.

4. The non-transitory computer-readable medium of claim 1, wherein the instructions executable to select the individual counteroffer from each of the number of clusters comprise instructions executable to select a cluster member from each of the number of clusters that is closest to the offer.

5. The non-transitory computer-readable medium of claim 1, wherein the determined distance comprises how related the content of each of the number of counteroffers is to one another, and wherein the determined distance is based on a negotiation history of the user.

6. The non-transitory computer-readable medium of claim 1, wherein the instructions executable to separate the plurality of counteroffers comprise instructions executable to separate the counteroffers utilizing graph clustering.

7. The non-transitory computer-readable medium of claim 6, wherein the instructions executable to separate the counteroffers utilizing graph clustering comprise instructions executable to:
coarsen a semantics graph associated with the plurality of counteroffers, the semantics graph containing a plurality of nodes in a number of sub-graphs containing multinodes;
partition each of the number of sub-graphs into a number of clusters; and
iteratively refine the number of clusters to reduce an edge-cut of the semantics graph, based on the number of clusters.

8. The non-transitory computer-readable medium of claim 1, comprising instructions executable to determine the plurality of counteroffers, separate the plurality of counteroffers into a number of clusters, select an individual counteroffer from each of the number of clusters, and present each of the individual counteroffers at each round of a negotiation.

9. The non-transitory computer-readable medium of claim 1, wherein the characteristics of the user comprise a negotiation history of the user and disclosed counteroffer preferences of the user.

10. A non-transitory computer-readable medium storing a set of instructions for determining a counteroffer executable by a processing resource to:
receive a first offer from a first user to a second user;
determine a plurality of potential counteroffers to the first offer based on the first offer and characteristics of the second user;
associate an issue vector with each of the plurality of potential counteroffers;
cluster the associated issue vectors based on their proximity to one another;
select, from each cluster, an issue vector that is closest to the first offer received by the second user; and
present the selected issue vectors as a plurality of first counteroffers to the first offer.

11. The non-transitory computer-readable medium of claim 10, comprising instructions executable to:
receive a second offer from the first user to the second user in response to the first plurality of counteroffers; and
determine and present a second plurality of counteroffers to the first user from the second user based on the second offer, characteristics of the second user, and clustered issue vectors associated with the second plurality of counteroffers.

12. The non-transitory computer-readable medium of claim 12, wherein the instructions executable to determine the second plurality of counteroffers comprise instructions executable to determine particular counteroffers that reduce a probability that the first user will terminate negotiations in response to receiving the second plurality of counteroffers.

13. A system, comprising:
a processing resource; and
a memory resource communicatively coupled to the processing resource containing instructions executable by the processing resource to:
determine a distance between each of a plurality of counteroffers to an offer presented by a first user and received by a second user based on a negotiation history of the first user and the second user;
determine a probability of acceptance of each of the plurality of counteroffers by the first user based on elements of the offer;
separate the plurality of counteroffers into a number of clusters based on the distance between each of the plurality of counteroffers and the probability of acceptance; and
select from each of the number of clusters a counteroffer to present to the first user.

14. The system of claim 13, wherein the instructions to separate the plurality of counteroffers into a number of clusters comprise instructions to separate the plurality of counteroffers such that intra-cluster counteroffer distances are below a particular threshold and inter-cluster counteroffer distances are above a particular threshold.

15. The system of claim 13, wherein the instructions executable to determine a distance between each of the plurality of counteroffers comprise instructions executable to determine a set of distance metrics between each of the plurality of counteroffers.
